(19) United States
(12) Patent Application Publication
(10) Pub. No.: US 2016/0136764 A1
(43) Pub. Date: May 19, 2016

(54) WELDING TORCH WITH GAS FLOW CONTROL

(71) Applicant: Lincoln Global, Inc., City of Industry, CA (US)

(72) Inventors: Edward A. ENYEDY, Eastlake, OH (US); William T. MATTHEWS, Chesterland, OH (US); William Delvon WILDER, Cleveland, OH (US)

(21) Appl. No.: 15/004,257

(22) Filed: Jan. 22, 2016

Related U.S. Application Data
(63) Continuation of application No. 13/291,621, filed on Nov. 8, 2011, now abandoned.

(51) Int. Cl. B23K 35/38

(52) U.S. Cl. CPC B23K 35/383

(57) ABSTRACT

An arc system is described which includes a power generator, a shielding gas source, a torch and a shielding gas monitor contained adjacent to or within the torch. The torch is connected to the power generator for producing an arc with a workpiece, is connected to the shielding gas source for providing shielding gas to an arc locations, and includes a flow sensor mounted within or adjacent the torch body for monitoring the flow of shielding gas through the torch and optimally providing feedback control of the shielding gas flow.

### CROSS-REFERENCE TO RELATED APPLICATIONS

This patent application claims priority to and is a continuation of U.S. patent application Ser. No. 13/291,621 filed Nov. 8, 2011, which is incorporated herein in its entirety.

### TECHNICAL FIELD

The present disclosure relates generally to welding systems, and more specifically, to a welding or cutting torch with gas flow control in proximity to the welding or cutting operation.

### BACKGROUND OF THE INVENTION

Welding is an important process in the manufacture and construction of various products and structures. Applications for welding are widespread and used throughout the world including, for example, the construction and repair of ships, buildings, bridges, vehicles, and pipe lines, to name a few. Welding is performed in a variety of locations, such as in a factory with a fixed welding operation or on site with a portable welder.

It is known in the welding industry to use a protective shielding gas, such as Argon, C02, or helium, around the arc and welding puddle in arc welding to protect molten metal from oxidation and to stabilize the arc for steady droplet transfer, particularly when performing gas metal arc welding (GMAW), commonly referred to as metal inert gas welding (MIG). In the MIG welding process molten metal is produced by an electric arc. This molten metal is derived from the materials to be welded and a filler wire. The filler wire is fed into the arc zone by a feeding mechanism. The molten weld metal is protected from the surrounding air by a shielding gas. A suitable power source is connected between the workpiece to be welded and to the filler wire passing through a welding torch. Welding power, welding filler wire and shielding gas are usually transported through the torch. The welding torch is usually attached to a flexible cable assembly and is manipulated by the welding operator.

Shielding gas is often supplied to the welding operation in high-pressure cylinders, one associated with each weld station. Fabricating shops with a large number of MIG welders may have the shielding gas distributed to each welding machine through a delivery pipeline from a centrally located gas source. A pressure-controlling regulator is employed to reduce the shielding gas pressure contained in the high-pressure cylinder or in the delivery pipeline to a lower pressure level. When an inert type gas or gas mixture is used it is common for this pressure to be reduced to a preset level, e.g., 25 psig (pounds per square inch above atmospheric pressure), 30 psig, or in some common regulators designed for shielding gas delivery service, 50 psig. The exact fixed output pressure level of the regulator is dependent on the manufacturer and model. For installations using carbon dioxide as a shielding gas supplied in cylinders, it is common to employ a regulator with 80 psig fixed output. This higher outlet pressure reduces the possible formation of ice crystals in the regulator/flow control system as the carbon dioxide gas pressure is reduced. A variable flow control valve or suitable flow control device is incorporated immediately after the regulator or is built into the regulator mechanism. This flow control device allows regulation of the shielding gas flow to the appropriate rate needed for welding. The flow control device may incorporate a flow measurement gauge.

It is also common for a flexible hose to be used to deliver the shielding gas from the cylinder or gas pipeline regulator and flow control device to the welding machine or wire-feeding device. It is most common for this hose to be ¼″ in internal diameter. In some instances the hose may be 3/16″ in inside diameter. To turn the flow of shielding gas on and off in commercial MIG welding systems, it is common to employ an electrically operated gas solenoid in the wire feeder or welding machine. A flexible hose connects the shielding gas supply to the solenoid at the welding machine. This hose is typically about 6 to 20 feet or longer in length to fit the needs of the welding installation. When welding is started, usually by means of an electrical switch on the welding torch, the gas solenoid is opened allowing shielding gas to flow through the welding torch to the weld zone. The electrical switch may simultaneously engage the wire feed mechanism and power source.

In most systems the flow of shielding gas is controlled by a flow control valve or other suitable flow control device at the regulator. The flow control device is adjusted to achieve the desired shielding gas flow. It is common for this flow to be set from 20 cubic feet per hour (CFH) to 40 CFH. Gas flows much in excess of this level can cause turbulence in the shielding gas stream as it exits the welding torch. This turbulence allows the surrounding air to be aspirated into the gas-shielding stream, degrading weld performance. In many systems, the pressure at the electrically operated gas solenoid needed to provide the proper flow of shielding gas is less than 5 to 10 psig. Therefore while welding is being performed, the pressure in the shielding gas delivery hose can be less than 5 to 10 psig.

While welding, the electric solenoid valve is open, and the gas pressure in the gas delivery hose is only that needed to establish the desired flow. The flow control device at the regulator is set for the desired shielding gas flow rate and indirectly establishes this pressure. This flow control device may incorporate a flow-measuring gauge to allow proper adjustment of shielding gas flow. When the proper shielding gas flow is set and welding commences the pressure in the gas delivery hose near the solenoid is typically less than 5 to 10 psig depending on the torch type, length, and plumbing restrictions. When welding is stopped the solenoid closes and flow of shielding gas from the solenoid to the torch stops. However the gas flow continues to fill the gas delivery hose until the gas pressure in the hose reaches the pressure set by the regulator. The pressure in the gas delivery hose than rises from what was needed to establish the proper flow level to the outlet pressure of the regulator, typically 25 psig, 30 psig, 50 psig, or 80 psig as mentioned above. The excess pressure stores shielding gas in the gas delivery hose connecting the regulator/flow control device to the welding machine or wire feeder until the solenoid is opened again at the start of the next weld. Once the weld is restarted, this excess shielding gas is expelled very rapidly, usually within less than about ½ to 3 seconds. These shielding gas flow rates can momentarily reach in excess of 100 CFH, much higher than needed and also higher than desirable for good weld quality. Weld start quality can be impaired because of excess shielding gas flow creating air aspiration into the shielding gas stream. The wasted shielding gas, although small for each occurrence, can be very significant over time. Depending on the number of starts and stops versus the overall welding time, the wasted shielding gas can exceed 50% of the total gas usage. A significant waste is described as attributable to the excess storage of shielding gas in a commonly employed 114″ inside diameter shielding gas delivery hose.

Orifice restriction devices help reduce high flow gas surge at the weld start and the resulting degradation of the weld but often do not eliminate or significantly reduce shielding gas waste and its associated detrimental effect on initial weld quality. The orifice size selected is usually significantly larger than needed to control the shielding gas flow at minimum needed levels. When welding has started, after a period of several seconds the flow-control device at the regulator determines the gas flow rate and indirectly the pressure at the solenoid valve. When welding, gas pressure in the shielding gas delivery hose at the solenoid valve end reduces to that needed to obtain the desired flow, for example for some torches and systems, 5 psig. This is usually significantly lower than the regulator fixed output pressure. At the end of the welding operation, the gas solenoid closes and the pressure in the shielding gas delivery hose increases to the delivery pressure of the regulator, i.e. 25, 30, 50, or 80 psig. Once welding commences the restriction orifice in most instances is not reducing shielding gas flow to the level established by the orifice. After several seconds, the flow rate reduces to the lower level set at the flow control device near or built into the regulator. Therefore, the pressure in the welding gas delivery hose near the solenoid end reduces to the level needed to achieve the desired flow, perhaps 5 psig.

Another method of reducing shielding gas waste and associated negative impact on initial weld quality, is by reducing the volume of shielding gas stored in the delivery hose. Assuming a given length hose is needed to achieve the desired welding machine configuration, the other dimension controlling the volume in the shielding gas delivery hose is the internal cross sectional area.

However, even the above approaches, while reducing the amount of shielding gas which is expelled upon startup, still does not regulate it. What is needed is flow control at the most critical juncture of the process, namely at the welding gun, which is the closest location to the welding operation.

### SUMMARY OF THE INVENTION

This invention relates to welding torches with gas flow control, where the gas flow sensing device is positioned relatively close to the workpiece, and preferably on the welding torch.

In at least one embodiment, the arc system, which includes both welding operations as well as cutting operations, includes a power generator, a shielding gas source, and a torch. The torch is connected to a power generator for producing an arc for application with a work piece. The torch is connected to a source of shielding gas for use in providing the shielding gas to various arc locations and applications. The torch includes a flow sensor mounted within a body of the torch for monitoring the flow of shielding gas through the torch.

In one aspect of the invention, the arc system includes a valve to control the flow of shielding gas through the torch, the valve optionally mounted within the body of the torch or relatively close thereto. The valve may be disposed before or after the gas sensor which is positioned in or on the torch body. As used in this invention, the torch may be selected from the group of cutting torches, e.g., a plasma cut torch, or welding torches, e.g., a MIG torch or a TIG torch.

In a preferred embodiment, the arc system includes a controller operatively connected to the flow sensor to adjust the valve based at least in part upon a signal from the sensor. The arc system may include a user input device for manually adjusting the valve. A display may be mounted to the to the torch body that shows the flow rate of the shielding gas.

Various aspects will become apparent to those skilled in the art from the following detailed description and the accompanying drawings.

### BRIEF DESCRIPTION OF THE DRAWINGS

FIG. 1 is a schematic view of a welding system;

FIG. 2a is a top view of the torch of FIG. 1;

FIG. 2b is a side view of the torch of FIG. 1 in partial cut-away;

FIG. 3a is a graph of trigger state during an arc operation;

FIG. 3b is a graph of current flow during the arc operation of FIG. 3a;and

FIG. 3c is a graph of gas flow during the arc operation of FIG. 3a.

### DETAILED DESCRIPTION

The best mode for carrying out the invention will now be described for the purposes of illustrating the best mode known to the applicant at the time of the filing of this patent application. The drawings and examples are illustrative only and not meant to limit the invention, which is measured by the scope and spirit of the claims.

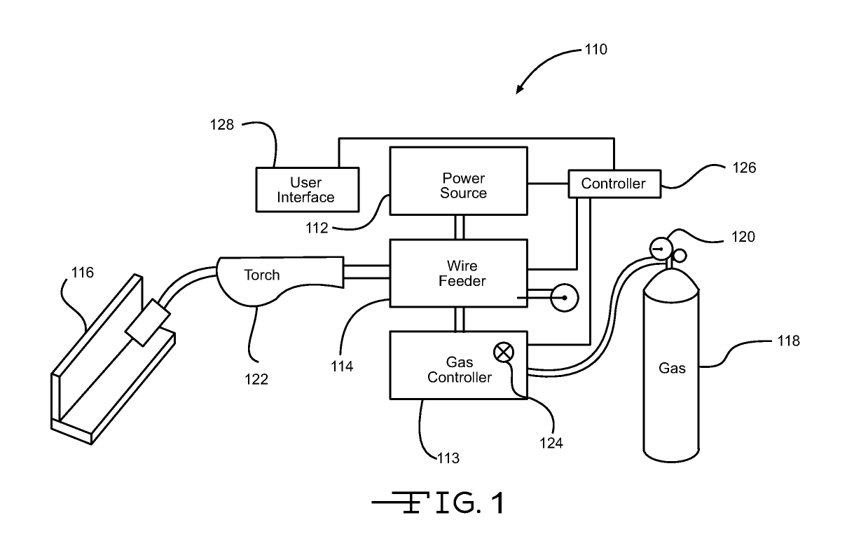

Referring now to FIG. 1, an arc system 110 is illustrated in accordance with one embodiment of the invention. Arc system 110 may be an arc cutting system, such as a plasma cutter, or the arc system may be an are welding system, such as a MIG welder or TIG welder. As shown in the Figure, arc system 110 includes power source 112, e.g., a cutting or welding power supply, an optional gas controller 113, and, in the case of a wire fed arc welding system, a wire feeder 114. When optional wire feeder is present, the wire feeder has a drive motor for delivering welding wire to a welding operation or workpiece 116.

Arc system 110 includes shielding gas source 118, which includes gas regulator 120 for regulating the flow of shielding gas from shielding gas source 118. Torch 122 is electrically connected to power source 112 for producing an arc with workpiece 116. In the case of a cutting operation, torch 122 is a cutting torch, e.g., a plasma cutting torch, while in the case of a welding operation, torch 122 is a welding torch, e.g., a MIG torch or TIG torch, etc. Torch 112 is also operatively and fluidly connected to shielding gas source 118 for providing a shielding gas to an arc at workpiece 116.

When optional gas controller 113 is present, shielding gas source 118 is connected in fluid communication with optional gas controller 113 and in fluid communication with torch 122. In one embodiment, optional gas controller 113 includes control valve 124 positioned at some distance away from the cutting or welding operation, for controlling the flow of shielding gas shielding gas source 118 through torch 122.

In one aspect of the invention, arc system 110 includes optional controller 126 operatively connected to power source 112, gas controller 113 and wire feeder 114 for automated operation of the arc system 110, as desired.

In another aspect of the invention, arc system 110 additionally includes an optional user input device 128 which may be employed in some instances, for at least partially manually adjusting remotely-positioned gas control valve 124 and/or optional wire feeder 114. For example, user input device 128 may be a welder's pedal, such as used in TIG welding, or it may be a microprocessor-based graphical user interface.

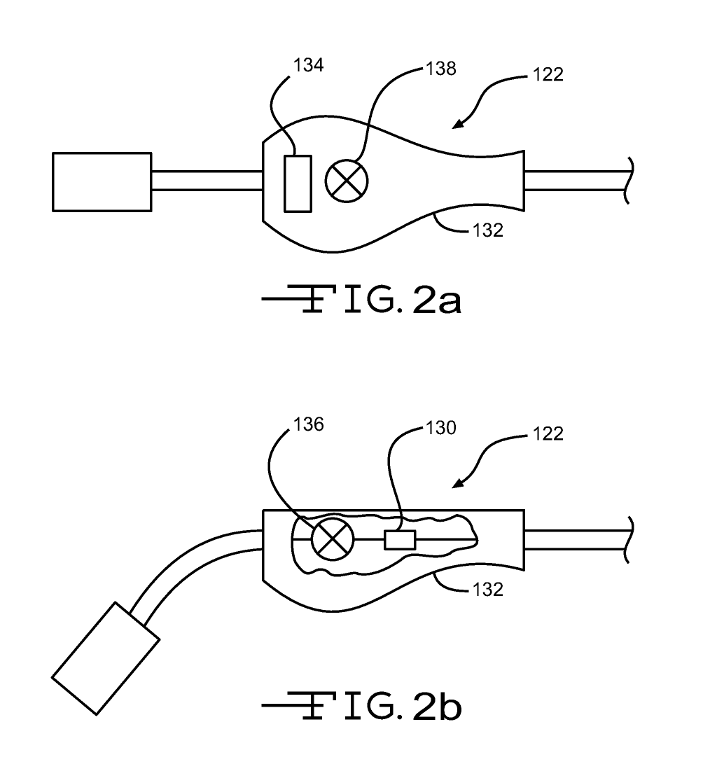

As best shown in FIG. 2b, torch 122 includes flow sensor 130 mounted within or adjacent to body 132 of torch 122 for monitoring the flow of shielding gas through torch 122 at a location adjacent the welding operation.

Optionally, flow rate display 134 is mounted to torch body 132 to visually show the flow rate of the shielding gas flowing through torch 122 as monitored by flow sensor 130. In one aspect of the invention, gas flow sensor 130 is contained within torch body 132 optionally with associated placement of gas torch valve 136. Placement in that manner permits better control of the shielding gas in that the closer the sensor and valve are to the welding arc, the better the accuracy of the gas flow. With the sensor and valve in the gun, the system can overcome leaks and errors caused by back pressure. Additionally, the shielding gas may be varied and/or pulsed so as to affect the arc and the weld puddle.

In one embodiment of the invention, gas flow sensor 130 is of the mass controller type (MEMS or micro electro-mechanical system) which detects mass flow by measuring deviations of the heat symmetry of the heater while being relatively insensitive to temperature or pressure, thereby enabling a wide range of gas flow measurements with high accuracy.

In one configuration, torch valve 136 is mounted within torch body 132 to control the flow of shielding gas through torch 122. This control may be at least partially based upon the flow rate as detected by the flow sensor 130. Torch 122 may further optionally include torch user input device 138 for manually adjusting the valve.

In at least one embodiment, controller 126 is operatively connected to flow sensor 130 and responsive to adjust control valve 124 and/or torch valve 136 based at least in part upon a signal from sensor 130.

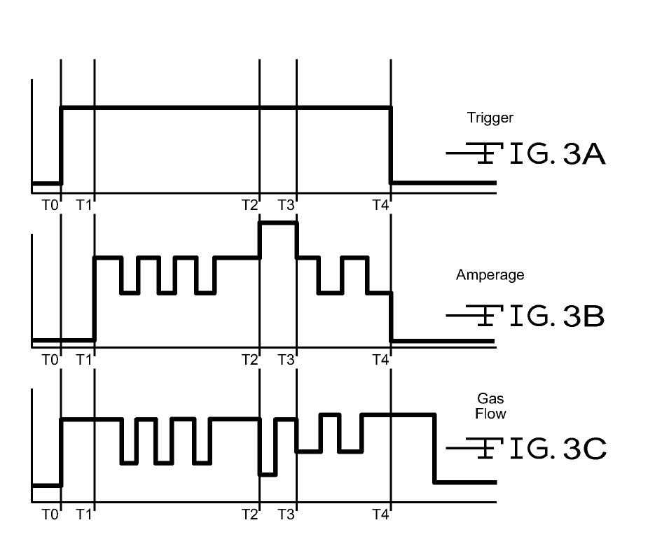

As better illustrated in FIGS. 3a, 3b, and 3c, an exemplary are operation begins at time TO where the trigger of torch is activated, amperage remains low, and shielding gas begins to flow at a predetermined rate. At time T1, while the trigger is still activated, the amperage is raised to a predetermined level and then the amperage and shielding gas flow rhythmically pulse. The amperage and shielding gas flow are illustrated as pulsing in unison, although such is not required. At time T2, while the trigger is still activated, when the wire reaches the work piece or a puddle there on to short in the case of a welding operation, or when the plasma cut is shorted with the work piece or a puddle there on in the case of a cutting operation, the amperage is raised to a higher level and the shield gas is reduced. Then at time T3, while the trigger is still activated, when the short is cleared, the amperage and gas flow return to a pulsing state, in this case the amperage and gas flow are shown as pulsing asymmetrically, although such is not required. Finally at time T4 the trigger is deactivated and the amperage is returned to a low state and after a predetermined period of time the gas flow is then also returned to a low state.

In one method of operation, an arc system is provided including a power generator, a shielding gas source, and a torch. The torch is connected to the power generator for producing an arc with a work piece and the torch is connected to the shielding gas source for providing shielding gas to an arc location. The torch includes a flow sensor mounted within a body of the torch for monitoring the flow of shielding gas through the torch.

Shielding gas is delivered from the shielding gas source to a work area through the torch. A current is generated with the power generator for creating an arc between the torch and the work piece. The flow of shielding gas through the torch is monitored with the flow sensor.

In a preferred embodiment, the arc system includes a shielding gas flow controller operatively connected to the shielding gas flow sensor. The valve may then be adjusted with the controller based at least in part upon a signal from the flow sensor or may be manually adjusted or combinations thereof.

Further a weld procedure may be selected via a user input and the adjusting of the valve may also be at least partially based upon the weld procedure selected. Additionally, the valve may be adjusting also at least partially based upon input from a user operator during an arc operation. The controller may rhythmically adjust the valve during an arc operation.

Thus, in at least one operation a user may set, maintain or change the flow rate of a shielding gas during a welding or cutting operation. As such, process spatter and fumes may be reduced during a welding or cutting operation.

In at least one embodiment a flow sensor or meter and a control valve or flow controller is disposed within a torch or welding/cutting gun. The shielding gas provided to the torch may be varied or pulsed so as to affect the arc as desired.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. An arc system comprising:
a power source;
a shielding gas source; and
a torch electrically connected to the power source and adapted to produce an electric arc;
wherein the torch is fluidly connected to the shielding gas source to provide a shielding gas near the electric arc; and
a gas flow sensor mounted within or adjacent to a body of the torch, wherein the gas flow sensor adapted to monitor the flow of the shielding gas through the torch, wherein the gas flow sensor is adapted to overcome leaks and errors from the shielding gas source to the torch.

2. The arc system of claim 1 further comprising a gas flow controller operable to selectively vary the flow of shielding gas from the shielding gas source.

3. The arc system of claim 2, wherein the gas flow controller is a regulator.

4. The arc system of claim 2, wherein the gas flow controller includes a control valve and a torch user input device in communication with the control valve and operable to manually adjust a flow rate of the shielding gas.

5. The arc system of claim 4, wherein the torch user input device is located on the torch.

6. The arc system of claim 2, wherein the gas flow controller is in communication with a control valve.

7. The arc system of claim 6, wherein the control valve is located on the torch.

8. The arc system of claim 6, wherein the control valve is located remotely from the torch.

9. The arc system of claim 6, wherein the gas flow controller is in communication with the gas flow sensor and adjusts the control valve based at least in part upon a signal from the gas flow sensor.

10. The arc system of claim 2, wherein the gas flow controller is adapted to selectively produce a pulsed flow of shielding gas.

11. The arc system of claim 10, wherein the pulsed flow of shielding gas pulses in unison with an amperage provided at the torch.

12. The arc system of claim 10, wherein the pulsed flow of shielding gas pulses asymmetrically relative to the amperage.

13. The arc system of claim 1, wherein with activation of the torch, the power source provides an amperage to generate the electric arc, wherein the amperage rhythmically pulses between an initial and an elevated amperage level in an initial state and the gas flow sensor causes the shielding gas to rhythmically pulse between an initial and an elevated level in the initial state until a short is detected in a welding operation or a plasma cut is shorted in a cutting operation with the workpiece, wherein the amperage is increased to a higher level and the shielding gas is reduced to a lower level during a short circuit stage, and further after the short is cleared, the amperage and the shielding gas returns to a non-synchronized rhythmic pulsing state, followed by the amperage returning to essentially the initial amperage, and the shielding gas returning to a lowered level a predetermined amount of time after the amperage decreases to the initial amperage.

14. The arc system of claim 1 further comprising a wire feeder adapted to deliver welding wire and a controller, wherein the controller is in communication with the power source, the shielding gas source, the wire feeder, and the gas flow sensor; and wherein the controller automatically adjusts the flow of shielding gas to the torch based on communication from at least one of the power source and the wire feeder.

15. The arc system of claim 1, wherein the gas flow sensor is a mass flow controller.

16. The arc system of claim 15, wherein the mass flow controller is adapted to detect heat symmetry deviations.

17. The arc system of claim 1 further comprising a display, wherein the display is in communication with the gas flow sensor, and wherein the display conveys information based on a signal from the gas flow controller.

18. The arc system of claim 17, wherein the display is mounted on the torch.

19. The arc system of claim 17, wherein the information includes at least a flow rate of the gas through the torch.

20. An arc system comprising:
a power generator,
a shielding gas source,
a torch connected to the power generator for producing an arc with a work piece and connected to the shielding gas source for providing shielding gas to an arc locations,
a means for monitoring the flow of shielding gas within the torch; and
a means for regulating the flow of shielding gas through the torch.

21. The arc system of claim 20 further comprising
a user input device for at least partially controlling the means for regulating.

22. The arc system of claim 20 further comprising:
a controller operatively connected to the means for regulating to adjust the means for regulating based at least in part upon a signal from the means for monitoring.

23. The arc system of claim 20 wherein the torch is selected from the group consisting of a plasma cutting torch, a MIG torch and a TIG torch.

24. The arc system of claim 20 further comprising:
a display mounted to the to the torch body that shows a flow rate of the shielding gas.

25. The arc system of claim 20, wherein the torch is selected from the group consisting of a plasma cut torch, a MIG torch and a TIG torch.
